(19) United States
(12) Patent Application Publication
(10) Pub. No.: US 2016/0266948 A1
(43) Pub. Date: Sep. 15, 2016

(54) Queued Messages Processing Method and Apparatus, Method and Apparatus for Controlling Messages to be Enqueued

(71) Applicant: HUAWEI DEVICE CO., LTD., Shenzhen (CN)

(72) Inventor: Guangyuan Gao, Bejing (CN)

(73) Assignee: Huawei Device Co. Ltd., Shenzhen (CN)

(21) Appl. No.: 15/030,951

(22) PCT Filed: Oct. 15, 2014
(86) PCT No.: PCT/CN2014/088656

§ 371 Date: Apr. 21, 2016

(30) Foreign Application Priority Data
Oct. 23, 2013 (CN) 201310504955.6

(51) Int. Cl. G06F 9/54; G06F 9/46

(52) U.S. Cl. CPC G06F 9/546; G06F 9/466

(57) ABSTRACT

A message queue processing method is provided, which includes receiving messages that need to be processed; classifying the messages according to a dependency relationship between the messages, and placing the classified messages in a corresponding processing queue group, where the processing queue group includes a parallel processing queue group and a serial processing queue group; acquiring a head node linked list in the processing queue group, where the head node linked list is a linked list obtained by connecting nodes of message linked lists corresponding to all different processing times in the corresponding processing queue group; and when a processing time of a corresponding node in the head node linked list arrives, performing processing on a message linked list of the node in the head node linked list.

### CROSS-REFERENCE TO RELATED APPLICATIONS

This application is a U.S. National Stage of International Application No. PCT/CN2014/088656, filed on Oct. 15, 2014, which claims priority to Chinese Patent Application No. 201310504955.6, filed on Oct. 23, 2013, both of which are hereby incorporated herein by reference in their entireties.

### TECHNICAL FIELD

The present disclosure relates to the field of information processing technologies, and in particular, to a queued messages processing method, a method for controlling messages to be enqueued, and an apparatus.

### BACKGROUND

A message processing mechanism (Handler) is one of core design mechanisms of Android, and the entire system is driven using messages. For example, a message queue is a message storage queue in a message processing class (Looper). In a message listening method in the Looper, a message is first taken out, and then a message distribution processing method in the Handler is invoked to perform processing on the message. In a message enqueuing method in the Handler class, a message is placed in a message queue. According to a loop method, a message is taken out of a head of a message storage queue each time. For messages that need to be processed at a same time, in the message enqueuing method in the Handler class, each message is placed in a position closest to a message queue head each time. The messages are arranged in a queue in a manner in which a message whose processing time is earlier is closer to a queue head; if a value filled in a processing time field is 0, it indicates that the message needs to be processed immediately. FIG. 1 is a schematic diagram of a sequence of enqueuing multiple messages. It is assumed that there are five messages A, B, C, D, E, and F that need to be processed immediately, one message comes every 100 milliseconds, and processing one message requires 1000 milliseconds. A sequence of enqueuing the messages is A, B, C, D, E, and F; a sequence of dequeuing and processing the messages is A, F, E, D, C, and B. It can be seen that the message B coming earlier is processed after the messages C/D/E/F coming later.

In a research and practice process of the prior art, the inventor of the present disclosure finds that in an existing implementation manner, a message coming later is processed prior to and a message coming earlier, which easily results in application not responding (ANR) and also reduces timeliness of message processing.

### SUMMARY

Embodiments of the present disclosure provide a message queue processing method, a method for controlling messages to be enqueued, and an apparatus, so as to resolve a technical problem in the prior art that timeliness of message processing is reduced because a message coming earlier is processed later.

To resolve the foregoing technical problem, the embodiments of the present disclosure disclose the following technical solutions.

A first aspect provides a message queue processing method, where the method is applied to an operating system of a mobile terminal, and the method includes receiving messages that need to be processed, performing classification according to a dependency relationship between the messages, and placing the classified messages in a corresponding processing queue group, where the processing queue group includes a parallel processing queue group and a serial processing queue group, acquiring a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group, and when a processing time of a corresponding node in the head node linked list arrives, performing processing on a message linked list of the node in the head node linked list.

In a first possible implementation manner of the first aspect, the method further includes, when a processing time of a next node arrives, linking a message linked list of the next node to a tail of a current linked list, where the next node is a node next to a node that is being processed currently in the parallel head node linked list or the serial head node linked list.

With reference to the first aspect or the first possible implementation manner of the first aspect, in a second possible implementation manner, the method further includes, after the message linked list of the next node is linked to the tail of the current linked list, deleting a node corresponding to the message linked list of the next node from the head node linked list, where the message linked list of the next node is a message linked list of the next node in the parallel head node linked list or the serial head node linked list.

With reference to the first aspect or the first or second possible implementation manner of the first aspect, in a third possible implementation manner, a head pointer field and a tail pointer field of each head node in the acquired head node linked list point to a head and a tail of the corresponding message linked list respectively, where each head node in the head node linked list includes each head node in the parallel head node linked list and each head node in the serial head node linked list.

With reference to the first aspect or the first, second, or third possible implementation manner of the first aspect, in a fourth possible implementation manner, the performing classification according to a dependency relationship between the messages, and placing the classified messages in a corresponding processing queue group includes determining whether indication information is included in the messages, and if the indication information is included, classifying the messages according to the indication information, and placing the classified messages in a corresponding message linked list at a corresponding time in the corresponding processing queue group, and if no indication information is included, placing the messages in a corresponding message linked list at a corresponding time in the corresponding serial processing queue group.

A second aspect provides a method for controlling messages to be enqueued, where the method includes receiving messages, and adding indication information to the messages, so that a processor receiving the messages classifies the messages according to the added indication information and performs parallel processing on the classified messages.

In a first possible implementation manner of the second aspect, the indication information includes a parallel identifier or a serial identifier.

A third aspect provides a message queue processing apparatus, applied to an operating system of a mobile terminal, where the apparatus includes a receiving unit configured to receive messages that need to be processed, a classification unit configured to perform classification according to a dependency relationship between the messages, and place the classified messages in a corresponding processing queue group, where the processing queue group includes a parallel processing queue group and a serial processing queue group, an acquiring unit configured to acquire a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group, and a processing unit configured to, when a processing time of a corresponding node in the head node linked list arrives, perform processing on a message linked list of the node in the head node linked list.

In a first possible implementation manner of the third aspect, the apparatus further includes a first determining unit configured to determine whether a processing time of a next node arrives, where the next node is a node next to a node that is being processed currently in the parallel head node linked list or the serial head node linked list, and a linking unit configured to, when the first determining unit determines that the processing time of the next node arrives, link a message linked list of the next node to a tail of a current linked list.

With reference to the third aspect or the first possible implementation manner of the third aspect, in a second possible implementation manner, the apparatus further includes a deletion unit configured to, after the linking unit links the message linked list of the next node to the tail of the current linked list, delete a node corresponding to the message linked list of the next node from the head node linked list, where the message linked list of the next node is a message linked list of the next node in the parallel head node linked list or the serial head node linked list.

With reference to the third aspect or the first or second possible implementation manner of the third aspect, in a third possible implementation manner, a head pointer field and a tail pointer field of each head node in the head node linked list, in the processing queue group, acquired by the acquiring unit point to a head and a tail of the corresponding message linked list respectively, and each head node in the head node linked list includes each head node in the parallel head node linked list and each head node in the serial head node linked list.

With reference to the third aspect or the first, second, or third possible implementation manner of the third aspect, in a fourth possible implementation manner, the classification unit includes a second determining unit configured to determine whether indication information is included in the messages, a first classification unit configured to, when the second determining unit determines that the indication information is included in the messages, classify the messages according to the indication information, a placing unit, placing the messages classified by the classification subunit in a corresponding message linked list at a corresponding time in the corresponding processing queue group, and a second classification unit configured to, when the second determining unit determines that no indication information is included in the messages, place the messages in a corresponding message linked list at a corresponding time in the corresponding serial processing queue group.

A fourth aspect provides an apparatus for controlling messages to be enqueued, including a receiving unit configured to receive messages, and an addition unit configured to add indication information to the received messages, so that a processor receiving the messages classifies the messages according to the indication information and performs processing on the classified messages.

In a first possible implementation manner of the fourth aspect, the indication information added to the received messages by the addition unit includes a parallel identifier or a serial identifier.

It can be known from the foregoing technical solutions that in the embodiments of the present disclosure, because to-be-processed messages are classified in advance according to a dependency relationship between the messages, and the classified messages are placed in a corresponding parallel processing queue group and a corresponding serial processing queue group, when a node of a parallel head node linked list in the parallel processing queue group and a node of a serial head node linked list in the serial processing queue group arrive, parallel processing may be performed on the node in the parallel head node linked list and the node in the serial head node linked list in the serial processing queue group, so as to improve timeliness of message processing. In addition, in the embodiments, through a first in first out mechanism, a message processing chance is fairer, and a probability of application not responding is reduced.

### BRIEF DESCRIPTION OF DRAWINGS

To describe the technical solutions in the embodiments of the present disclosure or in the prior art more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic diagram of a sequence of enqueuing multiple messages;

FIG. 2 is a flowchart of a message queue processing method according to an embodiment of the present disclosure;

FIG. 3 is a schematic structural diagram of a serial processing queue group according to an embodiment of the present disclosure;

FIG. 4 is a schematic structural diagram of a parallel processing queue group according to an embodiment of the present disclosure;

FIG. 5 is another flowchart of a message queue processing method according to an embodiment of the present disclosure;

FIG. 6 is a flowchart of a method for controlling messages to be enqueued according to an embodiment of the present disclosure;

FIG. 7 is a schematic structural diagram of a message queue processing apparatus according to an embodiment of the present disclosure;

FIG. 8 is a schematic structural diagram of an apparatus for controlling messages to be enqueued according to an embodiment of the present disclosure;

FIG. 9 is a schematic structural diagram of a mobile terminal according to an embodiment of the present disclosure; and

FIG. 10 is a schematic structural diagram of an application example of a mobile terminal according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

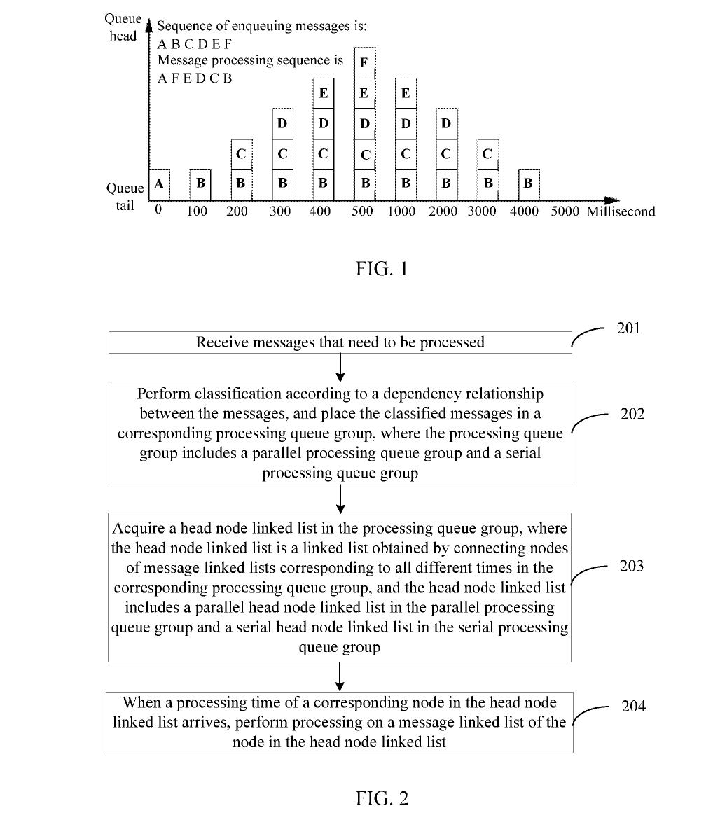

Referring to FIG. 2, FIG. 2 is a flowchart of a message queue processing method according to an embodiment of the present disclosure. The method is applied to an operating system of a mobile terminal, and the method includes the following steps.

Step 201: Receive messages that need to be processed.

In this step, after receiving the messages, an interface of the mobile terminal sends the messages to a processor. The message may be any message from the operating system, for example, an operation message sent by a system after a user performs an operation on an interface, or an instruction message sent by a system after a keystroke of a user.

Step 202: Perform classification according to a dependency relationship between the messages, and place the classified messages in a corresponding processing queue group, where the processing queue group includes a parallel processing queue group and a serial processing queue group.

In this step, it is first determined whether indication information is included in the messages; and if the indication information is included, the messages are classified according to the indication information and the classified messages are placed in a corresponding message linked list at a corresponding time in the corresponding processing queue group, and if no indication information is included, the messages are placed in a corresponding message linked list at a corresponding time in the corresponding serial processing queue group.

The indication information includes a parallel identifier and a serial identifier, that is, the messages are classified according to the parallel identifiers or the serial identifiers in the messages. If a message includes a parallel identifier, it indicates that the message is an independent message and that the message may be placed in a corresponding parallel processing queue group; if a message includes a serial identifier, it indicates that the message and a previous message are associated, for example, in a time sequence or in a way in which a processing result of a previously processed message is used for a currently processed message, and that the message may be placed in a corresponding serial processing queue group.

If a message does not include either a parallel identifier or a serial identifier, the message is placed in a corresponding message linked list at a corresponding time in a corresponding serial processing queue group.

For the dependency relationship, for example, there are a message A and a message B, a processing result of the message A needs to be used when the message B is processed, and therefore, there is a dependency relationship between the message A and the message B; otherwise, there is no dependency relationship between the message A and the message B, that is, both the message A and the message B are independent messages.

Step 203: Acquire a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group.

In this embodiment, the mobile terminal may acquire only the parallel head node linked list in the parallel processing queue group, may acquire only the serial head node linked list in the serial processing queue group, or certainly may acquire both the parallel head node linked list in the parallel processing queue group and the head node linked list in the serial processing queue group. In this embodiment, in order to distinguish head node linked lists in a parallel processing queue group and a serial processing queue group, the head node linked list in the parallel processing queue group is referred to as the parallel head node linked list, and the head node linked list in the serial processing queue group is referred to as the serial head node linked list.

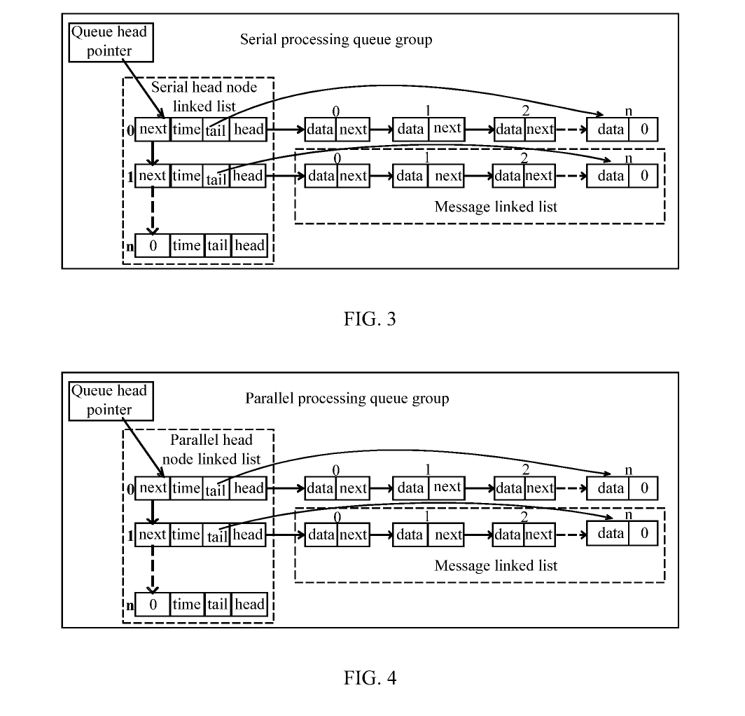

The serial head node linked list, message linked lists, and a queue head pointer in the serial processing queue group are shown in FIG. 3. FIG. 3 is a schematic structural diagram of a serial processing queue group according to this embodiment of the present disclosure. The parallel head node linked list, message linked lists, and a queue head pointer in the parallel processing queue group are shown in FIG. 4. FIG. 4 is a schematic structural diagram of a parallel processing queue group according to this embodiment of the present disclosure.

As shown in FIG. 3, the serial head node linked list includes nodes 0 to N, where N is a natural number, and each node corresponds to one message linked list. Each node includes a next node address (next), a processing time (time), a tail node address (tail) of a message linked list, and a head node address (head) of the message linked list; next in a 0^{th} node points to a first node, next in the first node points to a second node, until next in an (N−1)^{th} node points to 0 in an N^{th} node. Each message linked list includes message content (data) of each message (messages 0 to n are used as an example in FIG. 1, where n is a quantity of messages) and next next; next in a 0^{th} message points to a first message, next in the first message points to a second message, and by analogy, next in an (n−1)^{th} message points to an n^{th} message, where the n^{th} message is the last message. In addition, head in each node points to a 0^{th} message in a message linked list, and tail points to an n^{th} message. In addition, a queue head pointer points to the 0^{th} node.

A structure of the parallel processing queue group shown in FIG. 4 is similar to a structure of the serial processing queue group shown in FIG. 3, and a difference between the two structures lies in that the parallel processing queue group in FIG. 4 includes a parallel head node linked list, and the serial processing queue group shown in FIG. 3 includes a serial head node linked list. A structure of the parallel head node linked list and a structure of the serial head node linked list are the same.

A head node linked list may be acquired using a corresponding queue head pointer. For example, the parallel head node linked list in the parallel processing queue group is acquired using a queue head pointer of the parallel processing queue group, and the serial head node linked list in the serial processing queue group is acquired using a queue head pointer of the serial processing queue group.

Mutually independent messages received at different times are stored in the parallel processing queue group, messages received at each time form one message linked list (for example, message linked lists corresponding to a node 0 to a node N), nodes of the message linked lists at all the times are connected together, there is no interdependent relationship between the messages in the parallel processing queue group (that is, all the messages are independent messages), and data in all the messages is interconnected; in this case, the parallel head node linked list in the parallel processing queue group is obtained. Moreover, a head pointer and a tail pointer of each node in the parallel head node linked list point to a head and a tail of the corresponding message linked list respectively. That is, the parallel head node linked list includes head information of multiple nodes, and a head of each node corresponds to a data section, which is referred to as a message linked list in this specification; data information of messages is stored in the message linked list, and the data information of the messages is interconnected. Similarly, the serial head node linked list includes head information of multiple nodes, and a head of each node corresponds to a data section, which is referred to as a message linked list in this specification; data information of each message is stored in the message linked list, and the data information of the messages is interconnected.

That is, for the messages in both the parallel processing queue group and the serial processing queue group in this embodiment, whether the messages are independent messages (that is, messages having no association relationship with previous messages) or have an interdependent relationship with previously received messages is determined according to a dependency relationship (that is, the messages are associated in a time sequence) between the messages when the mobile terminal receives the messages. If the messages are independent messages, the messages are placed in the parallel processing queue group, or if there is an interdependent relationship, the messages are placed in the serial processing queue group. A specific determining manner may be performing determining according to the indication information in the messages. For example, indicator fields in the messages are used to indicate whether the messages are interdependent, or that flag bit information is added to idle fields of the messages.

Step 204: When a processing time of a corresponding node in the head node linked list arrives, perform processing on a message linked list of the node in the head node linked list.

In this step, when a processing time of a node in the parallel head node linked list arrives, processing is performed on a message linked list of the node of the parallel head node linked list; when a processing time of a node in the serial head node linked list arrives, processing is performed on a message linked list of the node in the serial head node linked list. That is, parallel processing may be performed on both a node in the parallel head node linked list and a node in the serial head node linked list.

In this embodiment, because the parallel head node linked list and the serial head node linked list each includes messages received at different times, messages of a same type received within a same time period are placed in a message linked list of a same node, for example, a message linked list corresponding to one node of a node 0 to a node N.

After a head node linked list in a corresponding queue is acquired, it is determined whether a processing time of a node in the corresponding head node linked list in the corresponding queue arrives; if the processing time arrives, corresponding processing is performed on data in a message linked list corresponding to the node in the serial and parallel head node linked lists.

That is, if a processing time of a node in the serial head node linked list arrives, all data in a message linked list of the node in the serial head node linked list is successively processed, where a processing process may be performed using a processing function; and if a processing time of a node in the parallel head node linked list arrives, all data in a message linked list of the node in the parallel head node linked list is successively processed, where a processing process may be performed using a processing function.

That is, the processing process of the node in the parallel head node linked list and the processing process of the node in the serial head node linked list are parallel processing processes.

In this embodiment of the present disclosure, a process of processing the messages in the serial processing queue group and a process of processing the messages in the parallel processing queue group are not absolutely the same. A processing principle for the serial processing queue group is a message is used for cyclically and continuously detecting the serial processing queue group. First, a serial head node linked list is obtained using a queue head pointer of the serial processing queue group, whether a processing time of a next node to which next in “the 0^{th} node” points arrives is checked, and if the processing time of the next node arrives, a message linked list of which the processing time arrives is placed at a tail of a current linked list. Then, it is determined whether the current linked list is empty; if the current linked list is not empty, a node is taken out of the current linked list and is processed using a processing function, and a next cycle starts after the processing is complete; if the current linked list is empty, this cycle ends, and a next cycle starts directly.

A processing principle for the parallel processing queue group is basically the same as the processing principle for the serial processing queue group, and a difference of the parallel processing queue group lies in that when it is determined that the current linked list is not empty, a message on a node is taken out of a head of the current linked list and is processed using a processing function, and without waiting for processing completion of the message, a message on a next node can be taken out for processing.

It should be noted that the serial processing queue group and the parallel processing queue group in this embodiment can be processed simultaneously on two threads.

In this embodiment of the present disclosure, to-be-processed messages are classified in advance according to a dependency relationship between the messages, and the classified messages are placed in a corresponding parallel processing queue group and a corresponding serial processing queue group. Therefore, when a node of a parallel head node linked list in the parallel processing queue group and a node of a serial head node linked list in the serial processing queue group arrive, parallel processing may be performed on the node in the parallel head node linked list and the node in the serial head node linked list in the serial processing queue group, so as to improve timeliness of message processing. In addition, in this embodiment, through a first in first out mechanism, a message processing chance is fairer, and a probability of application not responding is reduced.

Optionally, in another embodiment, where this embodiment is based on the foregoing embodiment, the method may further include determining, by the mobile terminal when processing a node using a processing function, whether a processing time of a next node of a node that is being processed currently arrives; if the processing time arrives, linking, to a tail of a current linked list, a message linked list of the next node of the node that is being processed currently, so that after processing of messages corresponding to the node that is being processed is complete, the message linked list of the next node is directly processed, which includes determining, by the mobile terminal, whether a processing time of a next node of a node that is being processed in the parallel head node linked list arrives, and if the processing time arrives, linking a message linked list of the next node in the parallel head node linked list to a tail of a current linked list (referred to as a first current linked list); and determining, by the mobile terminal, whether a processing time of a next node of a node that is being processed in the serial head node linked list arrives, and if the processing time arrives, linking a message linked list of the next node in the serial head node linked list to a tail of a current linked list (referred to as a second current linked list).

The first current linked list and the second current linked list in this embodiment are for distinguishing the messages in the parallel processing queue group and the messages in the serial processing queue group.

In this embodiment of the present disclosure, when a processing time of a node arrives, a message linked list corresponding to the node is first placed in a current linked list, so that after processing of a node that is being processed currently is complete, parallel processing is directly performed on message content in the message linked list, corresponding to the node, in the current linked list, thereby further improving processing efficiency. In addition, through a first in first out mechanism, a message processing chance is fairer, and a probability of application not responding is reduced.

Optionally, in another embodiment, where this embodiment is based on the foregoing embodiment, the method may further include, after the message linked list of the next node is linked to the tail of the current linked list, deleting a node corresponding to the message linked list of the next node from the head node linked list, where the message linked list of the next node is a message linked list of the next node in the parallel head node linked list or the serial head node linked list.

After the message linked list of the next node in the parallel head node linked list is linked to the tail of the first current linked list, a node corresponding to the message linked list of the next node of the node that is being processed in the parallel head node linked list is deleted; and after the message linked list of the next node in the serial head node linked list is linked to the tail of the second current linked list, a node corresponding to the message linked list of the next node of the node that is being processed in the serial head node linked list is deleted.

For example, a mobile terminal is performing processing on messages in a message linked list of a node 0 in a parallel head node linked list. The mobile terminal first reads a processing time of a next node (that is, a node 1), of the node 0, in the parallel head node linked list; then determines whether the processing time of the next node (that is, the node 1) in the parallel head node linked list arrives; if the processing time arrives, links a message linked list of the next node (that is, the node 1) in the parallel head node linked list to a current linked list tail (that is, a tail of a current linked list), and then, deletes a node corresponding to the message linked list of the next node from the parallel head node linked list.

For another example, a mobile terminal is performing processing on messages in a message linked list of a node 0 in a serial head node linked list. The mobile terminal first reads a processing time of a next node (that is, a node 1), of the node 0, in the serial head node linked list, then determines whether the processing time of the next node (that is, the node 1) in the serial head node linked list arrives; if the processing time arrives, links a message linked list of the next node (that is, the node 1) in the serial head node linked list to a current linked list tail (that is, a tail of a current linked list), and then, deletes a node corresponding to the message linked list of the next node from the serial head node linked list.

Certainly, parallel processing may also be performed simultaneously on the message linked list of the node 0 in the serial head node linked list and the message linked list of the node 0 in the parallel head node linked list. For specific processing, refer to the foregoing descriptions separately, and details are not repeatedly described herein.

In this embodiment of the present disclosure, messages are classified, and parallel processing is performed on the classified messages, so as to improve processing efficiency. In addition, through a first in first out mechanism, a message processing chance is fairer, and a probability of application not responding is reduced.

Optionally, in another embodiment, where this embodiment is based on the foregoing embodiment, the performing classification according to a dependency relationship between the messages, and placing the classified messages in a corresponding processing queue group includes when the messages are received, first determining, by the mobile terminal, whether there is a dependency relationship between the messages (determining may be performed according to whether indication information is included); and if there is a dependency relationship (that is, the indication information is included), classifying the messages according to the indication information, and placing the classified messages in a corresponding message linked list at a corresponding time in the corresponding processing queue group, and if there is no dependency relationship (that is, no indication information is included), placing the messages in a corresponding message linked list at a corresponding time in the corresponding serial processing queue group, where the indication information includes a parallel identifier or a serial identifier, and the indication information may be specifically in flag bits in the messages, dependency information or identification information may be added to an idle field of the messages, or the like.

The determining whether there is a dependency relationship between the messages may be determining, according to the indication information in the messages, whether there is a dependency relationship between the messages, where the indication information may be specifically in a flag bit in the messages, dependency information or identification information may be added to an idle field of the messages, or the like.

That is, if a message includes a parallel identifier, the message is placed in a parallel processing queue group; if a message includes a serial identifier, the message is placed in a serial processing queue group; if a message does not include either a parallel identifier or a serial identifier, the message is placed in a serial processing queue group.

Nodes of message linked lists corresponding to all different times in the parallel processing queue group are connected together to obtain a corresponding parallel head node linked list, and nodes of message linked lists corresponding to all different times in the serial processing queue group are connected together to obtain a corresponding serial head node linked list. A head pointer field and a tail pointer field of each node in the parallel head node linked list and the serial head node linked list point to a head and a tail of the corresponding message linked list respectively. A queue head pointer of the parallel processing queue group points to a node (that is, a 0^{th} node) being processed or to be processed in the parallel head node linked list, and a queue head pointer of the serial processing queue group points to a node (that is, a 0^{th} node) being processed or to be processed in the serial head node linked list.

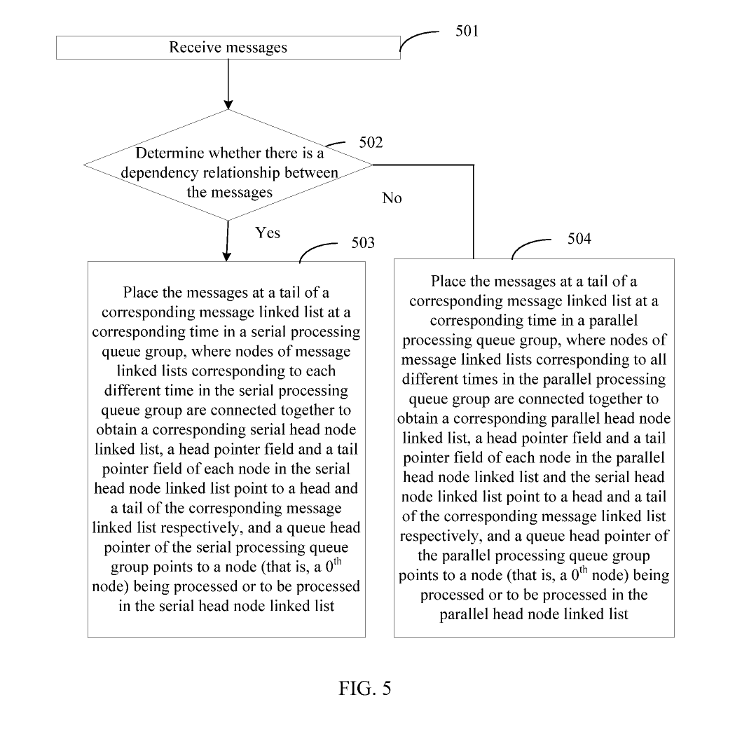

Referring to FIG. 5, FIG. 5 is another flowchart of a message queue processing method according to an embodiment of the present disclosure. The method includes the following steps.

Step 501: Receive messages, where the messages may be messages in a Handler message queue, may be messages sent by a system after a user performs an operation on an interface, and certainly, may also be other messages from an operating system.

Step 502: Determine whether there is a dependency relationship between the messages; and if yes, perform step 503, otherwise, perform step 504.

For description of determining whether there is a dependency relationship between the messages, refer to the foregoing descriptions, and details are not repeatedly described herein.

Step 503: Place the messages at a tail of a corresponding message linked list at a corresponding time in a serial processing queue group, where nodes of message linked lists corresponding to all different times in the serial processing queue group are connected together to obtain a corresponding serial head node linked list, a head pointer field and a tail pointer field of each node in the serial head node linked list point to a head and a tail of the corresponding message linked list respectively, and a queue head pointer of the serial processing queue group points to a node (that is, a 0^{th} node) being processed or to be processed in the serial head node linked list.

Step 504: Place the messages at a tail of a corresponding message linked list at a corresponding time in a parallel processing queue group, where nodes of message linked lists corresponding to all different times in the parallel processing queue group are connected together to obtain a corresponding parallel head node linked list, a head pointer field and a tail pointer field of each node in the parallel head node linked list and the serial head node linked list point to a head and a tail of the corresponding message linked list respectively, and a queue head pointer of the parallel processing queue group points to a node (that is, a 0^{th} node) being processed or to be processed in the parallel head node linked list.

In this embodiment, when receiving messages, a mobile terminal places the messages in a message linked list at a corresponding time in a serial processing queue group or a parallel processing queue group according to a dependency relationship between the messages. Messages that need to be processed at a same time in each queue are placed in a same message linked list, and each message linked list corresponds to one node. Nodes corresponding to all message linked lists are connected to form a head node linked list (if the queue is a serial queue, the head node linked list is a serial head node linked list; if the queue is a parallel queue, the head node linked list is a parallel head node linked list), and a queue head pointer points to a head of the head node linked list. A linked list including messages that are being processed at a current time is referred to as a current linked list. A head pointer field and a tail pointer field of the 0^{th} node in the head node linked list point to a head and a tail of the 0^{th} node, where the 0^{th} node may be empty, that is, there is no to-be-processed message.

In this embodiment of the present disclosure, messages are placed in a corresponding parallel processing queue group or serial processing queue group according to a dependency relationship between the messages, and then parallel processing is performed on the parallel processing queue group and serial processing queue group. That is, parallel processing on message queues is implemented in a form of double queues and multiple linked lists, thereby improving processing efficiency. In addition, through a first in first out mechanism, a message processing chance is fairer, and a probability of application not responding is reduced. That is, a first come first service mechanism is used to achieve fairness of message processing and a reduction in a probability of no response.

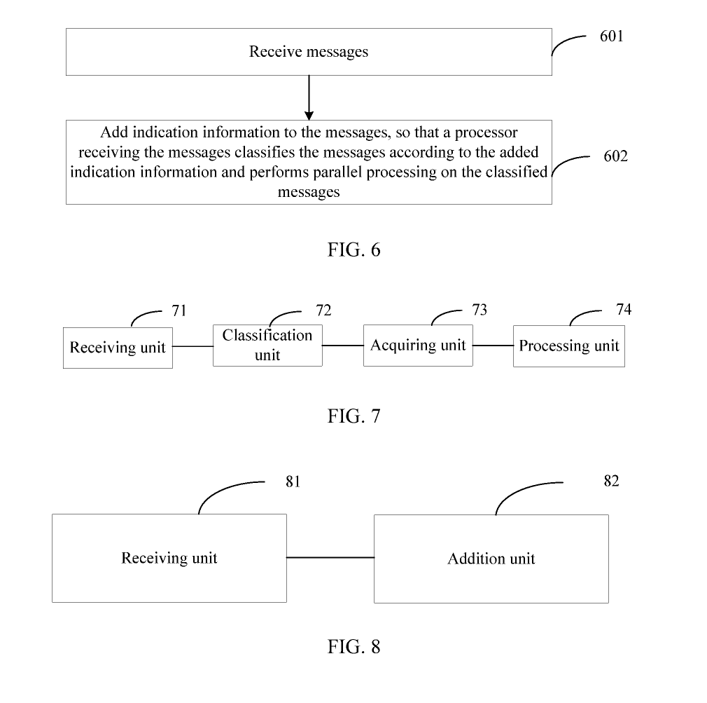

Correspondingly, referring to FIG. 6, FIG. 6 is a flowchart of a method for controlling messages to be enqueued according to an embodiment of the present disclosure. The method includes the following steps.

Step 601: Receive messages.

An interface of a mobile terminal receives externally sent messages.

Step 602: Add indication information to the messages, so that a processor receiving the messages classifies the messages according to the added indication information and performs parallel processing on the classified messages, where the indication information includes a parallel identifier or a serial identifier.

The indication information may be added to flag bits in the messages, the indication information may be added to empty fields of the messages, the indication information may be information indicating whether the messages are interdependent or independent or are identification information, or the like.

In this embodiment, the interface of the mobile terminal adds the indication information to the received messages, and sends, to the processor, messages to which the indication information is added, so that after receiving the messages to which the indication information is added, the processor classifies the messages according to the indication information, places the classified messages in a corresponding parallel processing queue group and a corresponding serial processing queue group, and performs parallel processing on the parallel processing queue group and the serial processing queue group, so as to improve timeliness of message processing.

Based on an implementation process of the foregoing method, an embodiment of the present disclosure further provides a queued messages processing apparatus, which is applied to an operating system of a mobile terminal. A schematic structural diagram of the processing apparatus is shown in FIG. 7, and the apparatus includes a receiving unit 71, a classification unit 72, an acquiring unit 73, and a processing unit 74. The receiving unit 71 is configured to receive messages that need to be processed. The classification unit 72 is configured to perform classification according to a dependency relationship between the messages, and place the classified messages in a corresponding processing queue group, where the processing queue group includes a parallel processing queue group and a serial processing queue group. The acquiring unit 73 is configured to acquire a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group. The processing unit 74 is configured to, when a processing time of a corresponding node in the head node linked list arrives, perform processing on a message linked list of the node in the head node linked list.

Optionally, the apparatus may further include a first determining unit and a linking unit. The first determining unit is configured to determine whether a processing time of a next node arrives, where the next node is a node next to a node that is being processed currently in the parallel head node linked list or the serial head node linked list. The linking unit is configured to, when the first determining unit determines that the processing time of the next node arrives, link a message linked list of the next node to a tail of a current linked list.

In this embodiment, the first determining unit may include a first determining subunit, and the connection unit may include a first linking unit; the first determining unit may include a second determining subunit, and the connection unit may include a second linking unit.

The first determining subunit is connected to the processing unit and is configured to determine whether a processing time of a next node of a node that is being processed in the parallel head node linked list arrives, and send a determining of arrival to the first linking unit; the first linking unit is configured to, when receiving the determining of arrival sent by the first determining unit, link a message linked list of the next node in the parallel head node linked list to a tail of a first current linked list.

The second determining subunit is connected to the processing unit and is configured to determine whether a processing time of a next node of a node that is being processed in the serial head node linked list arrives, and send a determining of arrival to the second linking unit; the second linking unit is configured to, when receiving the determining of arrival sent by the second determining unit, link a message linked list of the next node in the serial head node linked list to a tail of a second current linked list.

Optionally, the apparatus may further include a deletion unit configured to, after the linking unit links the message linked list of the next node to the tail of the current linked list, delete a node corresponding to the message linked list of the next node from the head node linked list, where the message linked list of the next node is a message linked list of the next node in the parallel head node linked list or the serial head node linked list.

Optionally, the deletion unit includes a first deletion unit and a second deletion unit. The first deletion unit is configured to, after the message linked list of the next node in the parallel head node linked list is linked to the tail of the first current linked list, delete a node corresponding to the message linked list of the next node from the parallel head node linked list; the second deletion unit is configured to, after the message linked list of the next node in the serial head node linked list is linked to the tail of the second current linked list, delete a node corresponding to the message linked list of the next node from the serial head node linked list.

Optionally, a head pointer field and a tail pointer field of each head node in the head node linked list, in the processing queue group, acquired by the acquiring unit point to a head and a tail of the corresponding message linked list respectively, and each head node in the head node linked list includes each head node in the parallel head node linked list and each head node in the serial head node linked list.

Optionally, the classification unit includes a second determining unit, a first classification unit, a placing unit, and a second classification unit, where the second determining unit is configured to determine whether indication information is included in the messages; the first classification unit is configured to, when the second determining unit determines that the indication information is included in the messages, classify the messages according to the indication information; the placing unit places the messages classified by the classification subunit in a corresponding message linked list at a corresponding time in the corresponding processing queue group; and the second classification unit is configured to, when the second determining unit determines that no indication information is included in the messages, place the messages in a corresponding message linked list at a corresponding time in the corresponding serial processing queue group.

For implementation processes of functions and effects of the units of the apparatus, refer to the corresponding implementation process in the foregoing method, and details are not repeatedly described herein.

In this embodiment of the present disclosure, received messages are first classified, next, the classified messages are placed in a corresponding parallel processing queue group and a corresponding serial processing queue group, and then, parallel processing is performed on the parallel processing queue group and the serial processing queue group, thereby improving timeliness of message processing.

An embodiment of the present disclosure provides an apparatus for controlling messages to be enqueued. A schematic structural diagram of the apparatus is shown in FIG. 8, and the apparatus includes a receiving unit 81 and an addition unit 82.

The receiving unit 81 is configured to receive the messages; the addition unit 82 is configured to add indication information to the received messages, so that a processor receiving the messages classifies the messages according to the added indication information and performs parallel processing on the classified messages.

The indication information added to the received messages by the addition unit includes a parallel identifier or a serial identifier.

For implementation processes of functions and effects of the units of the apparatus, refer to the corresponding implementation process in the foregoing method, and details are not repeatedly described herein.

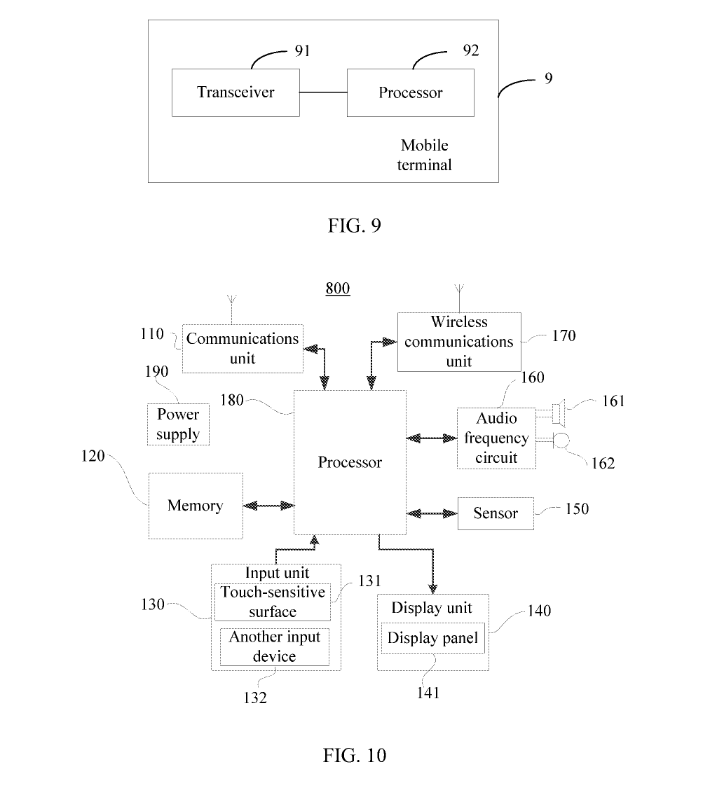

An embodiment of the present disclosure further provides a mobile terminal. A schematic structural diagram of the mobile terminal is shown in FIG. 9. The mobile terminal 9 includes a transceiver 91 and a processor 92. The transceiver 91 is configured to receive messages that need to be processed. The processor 92 is configured to perform classification according to a dependency relationship between the messages, and place the classified messages in a corresponding processing queue group, where the processing queue group includes a parallel processing queue group and a serial processing queue group. The transceiver 91 is further configured to acquire a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group. The processor 92 is further configured to, when a processing time of a corresponding node in the head node linked list arrives, perform processing on a message linked list of the node in the head node linked list.

Optionally, the processor is further configured to, when a processing time of a next node arrives, link a message linked list of the next node to a tail of a current linked list, where the next node is a node next to a node that is being processed currently in the parallel head node linked list or the serial head node linked list.

Optionally, the processor is further configured to, after the message linked list of the next node is linked to the tail of the current linked list, delete a node corresponding to the message linked list of the next node from the head node linked list, where the message linked list of the next node is a message linked list of the next node in the parallel head node linked list or the serial head node linked list.

Optionally, the transceiver is further configured to point, using a head pointer field and a tail pointer field of each head node in the head node linked list, to a head and a tail of the corresponding message linked list respectively, where each head node in the head node linked list includes each head node in the parallel head node linked list and each head node in the serial head node linked list.

Optionally, that the processor is further configured to classify the received message and place the classified messages in a corresponding processing queue group includes determining whether indication information is included in the messages; and if the indication information is included, classifying the messages according to the indication information, and placing the classified messages in a corresponding message linked list at a corresponding time in the corresponding processing queue group, and if no indication information is included, placing the messages in a corresponding message linked list at a corresponding time in the corresponding serial processing queue group.

For implementation processes of functions and effects of the transceiver and the processor of the mobile terminal, refer to the corresponding implementation process in the foregoing method, and details are not repeatedly described herein.

An embodiment of the present disclosure further provides another mobile terminal. The mobile terminal includes a transceiver and a processor. The receiver is configured to receive messages; the processor is configured to add indication information to the messages, so that the processor receiving the messages classifies the messages according to the added indication information and performs parallel processing on the classified messages.

For implementation processes of functions and effects of the transceiver and the processor of the mobile terminal, refer to the corresponding implementation process in the foregoing method, and details are not repeatedly described herein.

Correspondingly, an embodiment of the present disclosure further provides a mobile terminal. The mobile terminal includes a memory and one or more than one program, where the one or more than one program is stored in the memory and is configured so that one or more than one processor executes the one or more than one program, including instructions used to perform the methods provided in the embodiments of the present disclosure, including receiving messages that need to be processed; performing classification according to a dependency relationship between the messages, and placing the classified messages in a corresponding processing queue group, where the processing queue group includes a parallel processing queue group and a serial processing queue group; acquiring a head node linked list in the processing queue group, where the head node linked list is a linked list obtained by connecting nodes of message linked lists corresponding to all different times in the corresponding processing queue group, and the head node linked list includes a parallel head node linked list in the parallel processing queue group and a serial head node linked list in the serial processing queue group; and when a processing time of a corresponding node in the head node linked list arrives, performing processing on a message linked list of the node in the head node linked list.

For ease of understanding, refer to the following embodiment.

Referring to FIG. 10, FIG. 10 is a schematic structural diagram of an application example of a mobile terminal according to an embodiment of the present disclosure. The mobile terminal may be configured to implement the methods provided in the foregoing embodiments.

The mobile terminal 800 may include components such as a communications unit 110, a memory 120 including one or more than one computer-readable storage medium, an input unit 130, a display unit 140, a sensor 150, an audio frequency circuit 160, a WIFI module 170, a processor 180 including one or more than one processing core, and a power supply 190. A person skilled in the art can understand that no limitation is constituted on a mobile terminal by the structure of the mobile terminal shown in the figure, and the mobile terminal may include more or less components than those shown in the figure, or combine some components, or have different component deployments.

The communications unit 110 may be configured to receive and send information, or receive and send a signal in a call process, and the communications unit 110 may be a network communications device such as radio frequency (RF) circuit, a router, or a modem. Particularly, when the communications unit 110 is an RF circuit, after receiving downlink information from a base station, the communications unit 110 sends the downlink information to one or more than one processor 180 for processing, and sends related uplink data to the base station. Generally, the RF circuit used as the communications unit includes but is not limited to an antenna, at least one amplifier, a tuner, one or more oscillators, a subscriber identity module (SIM) card, a transceiver, a coupler, a low noise amplifier (LNA), a duplexer, and the like. In addition, the communications unit 110 may further communicate with a network and another device by means of wireless communication. Any communications standard or protocol can be used during wireless communication, where the standard or protocol includes but is not limited to Global System for Mobile Communications (GSM), general packet radio service (GPRS), code division multiple access (CDMA), wideband code division multiple access (WCDMA), long term evolution (LTE), an electronic message (email), a short message service (SMS), and the like. The memory 120 may be configured to store a software program and module. By running the software program and module that is stored in the memory 120, the processor 180 implements various functional applications and data processing. The memory 120 may mainly include a program storage area and a data storage area, where the program storage area may store an operating system, an application program required by at least one function (for example, a sound playback function or an image playback function), and the like; and the data storage area may store data (for example, audio data and a phonebook) created according to use of the mobile terminal 800, and the like. In addition, the memory 120 may include a high-speed random access memory, and may further include a non-volatile memory, such as at least one disk storage device, a flash memory device, or another volatile solid-state storage device. Correspondingly, the memory 120 may further include a memory controller, so as to provide access to the memory 120 for the processor 180 and the input unit 130.

The input unit 130 may be configured to receive input numeral or character information, and generate signal input, implemented using a keyboard, a mouse, a joystick, an optical technology, or a trackball, related to user settings and functional control. Preferably, the input unit 130 may include a touch-sensitive surface 131 and another input device 132. The touch-sensitive surface 131 is also referred to as a touch screen or a touchpad, and may collect a touch operation (for example, an operation performed by a user on or near the touch-sensitive surface 131 using a finger or any proper object or accessory such as a stylus) of a user on or near the touch-sensitive surface 131, and drive a corresponding connection device according to a preset program. Optionally, the touch-sensitive surface 131 may include two parts: a touch detection apparatus and a touch controller. The touch detection apparatus detects a touch orientation of the user, detects a signal brought by a touch operation, and transfers the signal to the touch controller. The touch controller receives touch information from the touch detection apparatus, converts the touch information to contact coordinates, and then sends the contact coordinates to the processor 180, and can receive and execute a command sent by the processor 180. In addition, the touch-sensitive surface 131 can be implemented in multiple types, such as a resistive type, a capacitive type, an infrared type, or a surface acoustic wave type. The input unit 130 may further include the another input device 132 in addition to touch-sensitive surface 131. Preferably, the another input device 132 may include but is not limited to one or more of a physical keyboard, a function key (for example, a volume control key or a power on/off key), a trackball, a mouse, and a joystick.

The display unit 140 may be configured to display information input by the user or information provided for the user and various graphical user interfaces of the mobile terminal 800, where these graphical user interfaces may include a graph, text, an icon, a video, and any combination thereof. The display unit 140 may include a display panel 141. Optionally, the display panel 141 may be configured in a form of a liquid crystal display (LCD), an organic light-emitting diode (OLED), or the like. Further, the touch-sensitive surface 131 can cover the display panel 141. After detecting a touch operation on or near the touch-sensitive surface 131, the touch-sensitive surface 131 transfers the touch operation to the processor 180, so as to determine a type of a touch event; then, the processor 180 provides corresponding visual output on the display panel 141 according to the type of the touch event. In FIG. 11, the touch-sensitive surface 131 and the display panel 141 are used as two independent components to implement input and input functions. However, in some embodiments, the touch-sensitive surface 131 and the display panel 141 may be integrated to implement the input and output functions.

The mobile terminal 800 may further include at least one sensor 150, such as a light sensor, a motion sensor, and another sensor. The light sensor may include an ambient light sensor and a proximity sensor, where the ambient light sensor may be used to adjust luminance of the display panel 141 according to brightness of ambient light, and the proximity sensor may be used to turn off the display panel 141 and/or backlight when the mobile terminal 800 is moved to an ear. As a motion sensor, a gravity accelerometer sensor can detect values of acceleration in all directions (generally three axes), can detect a value and a direction of gravity when static, and can be applied to an application (for example, screen switching between landscape and portrait, related games, and magnetometer posture calibration) for recognizing a mobile phone posture, a function related to vibration recognition (for example, a pedometer or a knock), and the like. For another sensor such as a gyroscope, a barometer, a hygrometer, a thermometer, or an infrared sensor that may also be configured in the mobile terminal 800, details are not described herein.

The audio frequency circuit 160, a loudspeaker 161, and a microphone 162 can provide an audio interface between the user and the mobile terminal 800. The audio frequency circuit 160 may transmit, to the loudspeaker 161, an electrical signal that is obtained after conversion of received audio data, and the loudspeaker 161 converts the electrical signal into an acoustic signal for outputting. In another aspect, the microphone 162 converts a collected acoustic signal into an electrical signal; the audio frequency circuit 160 receives and converts the electrical signal into audio data, and outputs the audio data to the processor 180 for processing; processed audio data is sent to, for example, another mobile terminal through the RF circuit 110, or audio data is output to the memory 120 for further processing. The audio frequency circuit 160 may further include an earplug jack, so as to provide communication between an external earphone and the mobile terminal 800.

In order to implement wireless communication, a wireless communications unit 170 may be configured on the mobile terminal, where the wireless communications unit 170 may be a WIFI module. WIFI belongs to a short-distance wireless transmission technology. The mobile terminal 800 can help, using the wireless communications unit 170, the user receive or send an email, browse a webpage, gain access to streaming media, and the like, and the WIFI module supplies the user with wireless broadband Internet access. Although the wireless communications unit 170 is shown in the figure, it can be understood that the wireless communications unit 170 is not a mandatory component of the mobile terminal 800 and may absolutely be omitted according to a demand without changing the essence of the present disclosure.

The processor 180 is a control center of the mobile terminal 800 and is connected to all components of the entire mobile phone using various interfaces and lines. By running or executing a software program and/or module that is stored in the memory 120 and invoking data stored in the memory 120, the processor 180 executes various functions of the mobile terminal 800 and processes data, so as to perform overall monitoring on the mobile phone. Optionally, the processor 180 may include one or more processing cores. Preferably, an application processor and a modem processor may be integrated into the processor 180, where the application processor mainly processes an operating system, a user interface, an application program, and the like, and the modem processor mainly processes wireless communication. It can be understood that the foregoing modem processor may also not be integrated into the processor 180.

The mobile terminal 800 further includes the power supply 190 (for example, a battery) supplying power to all components. Preferably, the power supply may be logically connected to the processor 180 using a power management system. In this way, functions such as charging and discharging management and power consumption management are implemented using the power management system. The power supply 190 may further include any component such as one or more than one of components such as a direct-current or alternating-current power supply, a recharging system, a power supply failure detection circuit, a power adapter or inverter, and a power status indicator.

The mobile terminal 800 may further include a camera, a Bluetooth® module, and the like that are not shown in FIG. 10, and details are not repeatedly described herein.

In this embodiment, the mobile terminal further includes a memory and one or more than one program, where the one or more than one program is stored in the memory and is configured so that one or more than one processor executes the one or more than one program, including instructions used to perform the methods provided in the embodiments of the present disclosure.

In addition, typically, the mobile terminal in the present disclosure may be any handheld mobile terminal such as a mobile phone or a personal digital assistant (PDA). Therefore, the protection scope of the present disclosure shall not be limited to a mobile terminal of a specific type.

In addition, the methods according to the present disclosure may also be implemented as a computer program executed by a central processing unit (CPU). When the computer program is executed by the CPU, the foregoing functions defined in the methods in the present disclosure are implemented.

In addition, the foregoing method steps and system units may also be implemented using a controller and a computer-readable storage device configured to store a computer program, where the computer program is used by a controller to implement the foregoing steps or functions of the foregoing units.

In addition, it should be understood that the computer-readable storage device (for example, a memory) described in this specification may be a volatile memory or non-volatile memory, or may include both a volatile memory and a non-volatile memory. By way of example and not by way of limitation, the non-volatile memory may include a read-only memory (ROM), a programmable ROM (PROM), an -erasable programmable ROM (EPROM), an electrically erasable programmable ROM (EEPROM), or a flash memory. The volatile memory may include a random access memory (RAM), where the RAM may be used as an external high-speed cache memory. By way of an example and not by way of limitation, the RAM may be obtained in multiple forms such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct Rambus RAM (DRRAM). The disclosed storage device intends to include but is not limited to these memories and memory of another proper type.

A person skilled in the art may further understand that, in combination of the disclosed descriptions herein, various exemplary logical blocks, modules, circuits, and algorithm steps may be implemented as electronic hardware, computer software, or a combination thereof. To clearly describe the interchangeability between the hardware and software, the foregoing has generally described functions of the various exemplary components, blocks, modules, circuits, and steps. Whether the functions are implemented as software or hardware depends on specific applications and design constraints imposed on the entire system. A person skilled in the art may implement the functions in various manners regarding every specific application, but this implementation shall not be interpreted as resulting in departing from the scope of the present disclosure.

The exemplary logic blocks, modules, and circuits disclosed herein may be implemented or executed using the following components that are designed and configured to implement the functions herein: a general-purpose processor, a digital signal processor (DSP), an application-specific integrated circuit (ASIC), a field programmable gate array (FPGA) or another programmable logic device, a discrete gate or transistor logic, a discrete hardware component, or any combination of these components. The general-purpose processor may be a microprocessor, but alternatively, the processor may be any traditional processor, controller, microcontroller, or state machine. The processor may also be implemented as a combination of computing devices, such as a combination of a DSP and a microprocessor, multiple microprocessors, one or more microprocessor combined with a DSP core, or such any other configuration.

The methods or steps of an algorithm disclosed herein may be directly included in hardware, software module run by a processor, or a combination of the hardware and software. The software module may reside in a RAM memory, a flash memory, a ROM memory, an EPROM memory, an EEPROM memory, a register, a hard disk, a removable hard disk, a compact disc ROM (CD-ROM), or a storage medium in any other form known in the art. Exemplarily, the storage medium is coupled to the processor, so that the processor can read information from the storage medium or write information in to the storage medium. In an alternate solution, the storage medium and the processor may be integrated together. The processor and the storage medium may reside in an ASIC. The ASIC may reside in a user terminal. In an alternate solution, the processor and the storage medium may be used as discrete components residing in a user terminal.

In one or more exemplary designs, the functions may be implemented in hardware, software, firmware, or any combination thereof. If the functions are implemented in software, the functions may be used as one or more instructions or code stored on a computer-readable medium or transferred using a computer-readable medium. The computer-readable medium includes a computer storage medium and a communications medium, where the communications medium includes any medium contributing to transferring of a computer program from a location to another location. The storage medium may be any available medium that can be accessed by a general- or special-purpose computer. By way of example and not by way of limitation, the computer-readable medium may include a RAM, a ROM, an EEPROM, a CD-ROM, or another optical disc storage device or disk storage device, or another magnetic storage device, or any other medium that can carry or store required program code in a form of an instruction or a data structure and can be accessed by a general- or special-purpose computer or a general- or special-purpose processor. In addition, any connection may be appropriately defined as a computer-readable medium. For example, if software is transmitted from a website, a server, or another remote source using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in a definition of a medium. The magnetic disk and optical disc used herein include a compact disk (CD), a laser disk, an optical disc, a digital versatile disc (DVD), a floppy disk, and a Blu-ray disc, where the magic disk generally magnetically reproduces data, and the optical disc optically reproduce data using laser. A combination of the foregoing content shall fall within the scope of the computer-readable medium.

It should be noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or a device that includes a list of elements not only includes those elements but also includes other elements that are not expressly listed, or further includes elements inherent to such a process, method, article, or device. An element preceded by “includes a . . . ” does not, without more constraints, preclude the presence of additional identical elements in the process, method, article, or device that includes the element.

Although exemplary embodiments of the present disclosure are described in the foregoing disclosed content, it should be noted that multiple changes and modifications may be made without departing from the scope of the present disclosure limited by claims. The functions, steps, and/or actions in method claims of the disclosed embodiments herein do not need to be performed in any specific sequence. In addition, although the elements in the present disclosure may be described or requested in an individual form, but for each type of element, there may also be multiple elements supposedly unless an element is limited to being singular.

In the foregoing specific implementation manners, the objective, technical solutions, and benefits of the present disclosure are further described in detail. It should be understood that the foregoing descriptions are merely specific implementation manners of the present disclosure, but are not intended to limit the protection scope of the present disclosure. Any modification, equivalent replacement, or improvement made without departing from the spirit and principle of the present disclosure shall fall within the protection scope of the present disclosure.

1.-14. (canceled)

15. A queued messages processing method, wherein the method is applied to an operating system of a mobile terminal, and the method comprises:
receiving messages to be processed;
classifying the messages according to a dependency relationship between the messages;
placing the classified messages in a corresponding processing queue group, wherein the processing queue group comprises a parallel processing queue group and a serial processing queue group;
acquiring a head node linked list in the processing queue group, wherein the head node linked list is a linked list obtained by connecting nodes of message linked lists corresponding to all different processing times in the corresponding processing queue group, and wherein the head node linked list comprises a parallel head node linked list in the parallel processing queue group and a serial head node linked list in the serial processing queue group; and
processing a message linked list of a node in the head node linked list when a processing time of the node in the head node linked list arrives.

16. The method according to claim 15, further comprising:
linking a message linked list of a next node to a tail of a current message linked list when a processing time of the next node arrives, wherein the next node is a node next to a currently processed node in the parallel head node linked list or the serial head node linked list.

17. The method according to claim 16, further comprising deleting a node corresponding to the message linked list of the next node from the head node linked list after the message linked list of the next node is linked to the tail of the current message linked list, wherein the message linked list of the next node is a message linked list of the next node in the parallel head node linked list or the serial head node linked list.

18. The method according to claim 15, wherein a head pointer field and a tail pointer field of each node in the head node linked list point to a head and a tail of a message linked list corresponding to the each node respectively, and wherein each head node in the head node linked list comprises each head node in the parallel head node linked list and each head node in the serial head node linked list.

19. The method according to claim 18, wherein classifying the messages according to the dependency relationship between the messages, and placing the classified messages in the corresponding processing queue group comprises:
determining whether indication information is comprised in the messages;
classifying the messages according to the indication information when the indication information is comprised;
placing the classified messages in a corresponding message linked list at a corresponding time in the corresponding processing queue group when the indication information is comprised; and
placing the messages in a corresponding message linked list at a corresponding time in the serial processing queue group when no indication information is comprised.

20. A method for controlling messages to be enqueued, comprising:
receiving messages; and
adding indication information to the messages such that a processor receiving the messages classifies the messages according to the added indication information and performs parallel processing on the classified messages.

21. The method according to claim 20, wherein the indication information comprises a parallel identifier or a serial identifier.

22. A mobile terminal, comprising at least a processor and a memory, wherein the memory stores program code such that when executed by the processor cause the mobile terminal to;
receive messages to be processed;
classify the messages according to a dependency relationship between the messages;
place the classified messages in a corresponding processing queue group, wherein the processing queue group comprises a parallel processing queue group and a serial processing queue group;
acquire a head node linked list in the processing queue group, wherein the head node linked list is a linked list obtained by connecting nodes of message linked lists corresponding to all different processing times in the corresponding processing queue group, and the head node linked list comprises a parallel head node linked list in the parallel processing queue group and a serial head node linked list in the serial processing queue group; and
process a message linked list of a node in the head node linked list when a processing time of the node in the head node linked list arrives.

23. The mobile terminal according to claim 22, wherein the program code further comprises instructions for executing to cause the mobile terminal to link a message linked list of a next node to a tail of a current message linked list when a processing time of the next node arrives, and wherein the next node is a node next to a currently processed node in the parallel head node linked list or the serial head node linked list.

24. The mobile terminal according to claim 23, wherein the program code further comprises instructions for executing to cause the mobile terminal to delete a node corresponding to the message linked list of the next node from the head node linked list after the message linked list of the next node is linked to the tail of the current message linked list, and wherein the message linked list of the next node is a message linked list of the next node in the parallel head node linked list or the serial head node linked list.

25. The mobile terminal according to claim 22, wherein a head painter field and a tail pointer field of each node in the head node linked list point to a head and a tail of a message linked list corresponding to the each node respectively, and wherein each head node in the head node linked list comprises each head node in the parallel head node linked list and each head node in the serial head node linked list.

26. The mobile terminal according to claim 25, wherein classifying the messages according to the dependency relationship between the messages, and placing the classified messages in the corresponding processing queue group comprises:
determining whether indication information is comprised in the messages;
classifying the messages according to the indication information when the indication information is comprised;
placing the classified messages in a corresponding message linked list at a corresponding time in the corresponding processing queue group when the indication information is comprised; and
placing the messages in a corresponding message linked list at a corresponding time in the serial processing queue group when no indication information is comprised.

27. A mobile terminal, comprising at least an processor and a memory, wherein the memory stores program code, the program code comprising instructions such that when executed by the processor cause the mobile terminal to:
receive messages; and
add indication information to the messages such that a processor receiving the messages classifies the messages according to the added indication information and performs parallel processing on the classified messages.

28. The mobile terminal according to claim 27, wherein the indication information comprises a parallel identifier or a serial identifier.
